(19) United States
(12) Patent Application Publication
(10) Pub. No.: US 2002/0165973 A1
(43) Pub. Date: Nov. 7, 2002

(54) Adaptive transport protocol

(76) Inventors: Doron Ben-Yehezkel, Newport Beach, CA (US); John Baker, Playa Del Rey, CA (US)

Correspondence Address: J.D. Harriman II, COUDERT BROTHERS, 333 South Hope Street, 23rd Floor, Los Angeles, CA, 90071, US

(21) Appl. No.: 09/839,383

(22) Filed: Apr. 20, 2001

(51) Int. Cl. G06F 15/16

(52) U.S. Cl. 709/230; 709/203

(57) ABSTRACT

Embodiments of the present invention relate to an adaptive transport protocol (ATP). A uniform datagram protocol (UDP) is used by one or more embodiments of the present invention to transmit the ATP data across a medium. When packets are lost and subsequent packets are received, the subsequent packets do not need to be re-sent if the lost packets later arrive, as in TCP/IP. One embodiment of the present invention builds an expected acknowledge time into the ATP data on top of the existing UDP protocol. The expected acknowledge time may be applied to every packet transmitted through the medium. When the expected acknowledge time in the medium changes, for instance if another transmission enters the shared environment or the characteristics of the transmission medium otherwise change, the expected acknowledge time is modified. If some of the packets in the window are not received by their expected acknowledge times, those packets are re-sent and the complete window of packets is re-ordered.

### BACKGROUND OF THE INVENTION

1. Field of the Invention

The present invention relates to communications, and in particular an adaptive protocol for the transport of data via a communication medium.

2. Background Art

A protocol is a format for transmitting data across a computer network One protocol that is used widely is called “Transmission Control Protocol/Internet Protocol” (TCP/IP). TCP/IP works well in environments where the network is connected physically, for instance with wires. TCP/IP, however, does not work as well when a wireless medium is used to pass data across the network Before further discussing the drawbacks associated with TCP/IP in a wireless environment, some general background information is presented.

Internet

The Internet is a network connecting many computer networks and is based on TCP/IP. From its creation it grew rapidly beyond its largely academic origin into an increasingly commercial and popular medium. By the mid-1990s the Internet connected millions of computers throughout the world. Many commercial computer network and data services also provided at least indirect connection to the Internet.

The original uses of the Internet were electronic mail (e-mail), file transfers (ftp or file transfer protocol), bulletin boards and newsgroups, and remote computer access (telnet). The World Wide Web (web), which enables simple and intuitive navigation of Internet sites through a graphical interface, expanded dramatically during the 1990s to become the most important component of the Internet. The web gives users access to a vast array of documents that are connected to each other by means of links, which are electronic connections that link related pieces of information in order to allow a user easy access to them. Hypertext allows the user to select a word from text and thereby access other documents that contain additional information pertaining to that word; hypermedia documents feature links to images, sounds, animations, and movies.

The web operates within the Internet's basic client-server format; Servers are computer programs that store and transmit documents (i.e., web pages) to other computers on the network when asked to, while clients are programs that request documents from a server as the user asks for them. Browser software allows users to view the retrieved documents. A web page with its corresponding text and hyperlinks is normally written in HTML or XML and is assigned an online address called a Uniform Resource Locator (URL).

Internet Protocol

Every device on a network needs a unique address so that data intended for the device can be routed to it. Internet Protocol (IP) defines a format for assigning addresses and defines a method for transferring unreliable data called a datagram. IP datagrams are encapsulated as the data portion of lower-level protocols such as Ethernet or token ring. An IP datagram consists of an IP header followed by data that is referred to as the payload. FIG. 16 shows an example of an IP datagram.

With reference to FIG. 16, the IP addresses are 32 bit values that identifythe source and destination devices for the payload. Tihe length field is a 16 bit value that specifies the length of the IP datagram, including the header, in 8-bit bytes. The IHL (Internet Header Length) is a four-bit field that specifies the header length in units of 32-bit words. The Checksum field ensures that the -IP header has been correctly received. The payload is not included in the checksum so the IP protocol provides no information on the reliability of the IP datagram payload. The Time To Live field is effectively a count of the number of nodes (host computers, routers, etc.) that the packet can still visit before it is discarded. Each node decrements the count and the packet is discarded if the count reaches zero.

The Protocol field identifies the next higher level protocol that is used for the data in the payload so that the IP layer can identify the correct higher layer to receive the datagram. Two of the possible IP Protocols are the Transport Control Protocol (TCP) and the User Datagram Protocol (UDP). Both TCP and UDP use IP as their means of delivering their own data. Together these protocols cover the network and transport layers (layers 3 and 4) of the ISO/OSI (International Organization for Standardization Open Systems Interconnection) seven-layer model.

TCP/IP

TCP/IP (Transport Control Protocol/Internet Protocol) has been the standard protocol in use for most communication processes for a large percentage of applications and platforms because it provides a reliable, error-free, full-duplex channel between two computers connected by a networks TCP is a connection-oriented protocol and manages the connection data as a single stream of bytes. TCP uses IP datagrams to actually transfer the data but uses its own mechanisms to handle lost, duplicate, and out of order datagrams to remove any notion of message boundaries from the applications using TCP. Applications use the TCP/IP protocol to send streams of data between computers without any awareness of the packet nature and characteristics of the actual data transfer. The TCP segment header is shown in FIG. 17.

TCP/IP has proven dependable in environments where one or more computing devices are connected via physical connections like phone lines. In a wireless environment however, where there is a relatively slow data transfer with a large amount of potential data loss, TCP/IP has proven less effective. Namely, a wireless medium is subject to constraints that do not exist in a wired medium. In particular, when sending data from point A to point B in a wireless medium, the amount of data loss increases, and the characteristic of the connection varies over time since a wireless environment is subject to problems such as quality variances, synchronization errors, multipath interference, attenuation, EMI interference, and fading that are absent from a wired connection. Thus, unlike a wired network, a wireless environment may only guarantee transmissions some of the time through a medium having variable bandwidth.

As a result, TCP/IP performance suffers on a wireless network. For example, FIG. 1 shows a packet window consisting of a series of ten packets transmitted via the TCP/IP protocol. Packets 1 and 2 are received, packets 3 and 4 are not received because of data loss, and packets 5, 6, and 7 are received. Using the TCP/IP algorithms, any loss of data results in the re-sending of the entire packet window. So, despite the fact that packets 5, 6, and 7 are received, they must be sent again because packets 3 and 4 did not arrive. TCP/IP ignores packets 5, 6, and 7 despite their receipt. Typically, in a situation such as that shown in FIG. 1, the TCP/IP protocol increases a timeout period when it realizes that packets 3 and 4 were not received in time. (The timeout period is a time that the TCP/IP algorithm determines that it expects the receipt of packets 3 and 4). By increasing the timeout period, TCP/IP waits for the packets to come and does nothing with any subsequent packets. If the packets are still not received, TCP/IP continues to increase the timeout period.

In a wireless environment, where packet loss is more common and latency is increased, the TCP/IP algorithms are more problematic. Since packet loss is more frequent, many re-transmissions of identical packets are introduced. In an environment where transmission speed is reduced by its nature, such a constant re-sending of packets becomes prohibitively slow and less suited for the environment. In addition, in a wireless environment where the time that a user is connected is relatively expensive, having the protocol at a receiving end of a transmission wait for packets while performing no other useful activity is costly. Correspondingly, a protocol that continually increases a timeout period for un-received packets compounds the problem.

### SUMMARY OF THE INVENTION

Embodiments of the present invention relate to an adaptive wireless transport protocol. A uniform datagram protocol (UDP) is used by one or more embodiments of the present invention to transmit data across a wireless medium. When packets are lost and subsequent packets are received, the subsequent packets do not need to be re-sent if the lost packets later arrive, as in TCP/IP.

One embodiment of the present invention builds an expected acknowledge time before a packet is considered late into the existing UDP protocol. The expected acknowledge time may be applied to every packet transmitted through the wireless medium or it may be applied at different intervals. When the expected acknowledge time in the wireless medium changes, for instance if another transmission enters the shared environment or the characteristics of the transmission medium otherwise change, the expected acknowledge time is modified.

For instance, if the wireless connection becomes busy, the expected acknowledge time is shifted to a later time and this later acknowledge time is applied to all packets that are currently in-flight through the medium In another embodiment, the amount of data sent in each packet is changed based upon the shifting of the expected acknowledge time and the characteristics of the channel.

The expected acknowledge time is computed by measuring the time it takes for a packet to be sent from a client to a server and have the client receive an acknowledgment that the server received the packet. A timeout period is determined using the expected acknowledgment time. If some of the packets in the window are not received by the timeout period, those packets are re-sent. When a complete window of packets is received, they are re-ordered.

In one embodiment, the volatility of the channel is calculated in real-time. As a large series of packets is transmitted, the variation in the expected acknowledge times is determined. If the variance is relatively large, then it is determined that the channel is volatile and the timeout for the expected acknowledgment time should be extended further into the future. If the variance is relatively small, then the timeout periods maybe reduced (i.e., if the packets do not arrive it is very likely that they were lost in transit and not delayed to arrive at a later time).

### BRIEF DESCRIPTION OF THE DRAWINGS

These and other features, aspects and advantages of the present invention will become better understood with regard to the following description, appended claims and accompanying drawings where:

FIG. 1 shows a series of ten packets to be handled using a TCP/IP protocol.

FIG. 2A shows an application send thread according to an embodiment of the present invention.

FIG. 2B shows an ATP send thread according to an embodiment of the present invention.

FIG. 3A shows an application receive thread according to an embodiment of the present invention.

FIG. 3B shows an ATP receive thread according to an embodiment of the present invention.

FIG. 4 shows the initialization of the client server connection according to an embodiment of the present invention.

FIG. 5 shows an expected acknowledgment time (remote RTO) calculation according to an embodiment of the present invention.

FIG. 6 shows a send delay time adjustment according to an embodiment of the present invention.

FIG. 7 shows the complete initialization, data transfer, and finalization processes according to an embodiment of the present invention.

FIG. 8 illustrates how embodiments of the present invention adjust the expected arrival times of packets.

FIG. 9 shows a block diagram of how one embodiment of the adaptive transport protocol functions.

FIG. 10 shows a connection termination process according to one embodiment of the present invention.

FIG. 11 shows an example of a UDP encapsulation of an IP datagram.

FIG. 12 shows data piggybacking according to an embodiment of the present invention.

FIG. 13 shows a channel volatlity calculation according to an embodiment of the present invention.

FIG. 14 shows dynamic packet sizing according to an embodiment of the present invention.

FIG. 15 shows how firewalls are managed according to one embodiment of the present invention.

FIG. 16 shows an example of an IP datagram.

FIG. 17 shows a TCP segment header.

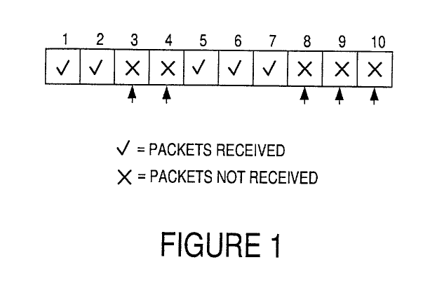

### DETAILED DESCRIPTION OF THE INVENTION

Embodiments of the present invention relate to an adaptive wireless transport protocol. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Adaptive Transport Protocol

According to one or more embodiments of the present invention an adaptive transport protocol (ATP) is used. ATP is a protocol built on top of the UDP protocol that is used for both client-to-server and server-to-client communication. Only the connection process has a defined client and server role since there maybe many clients for a server. The ATP protocol is used to provide TCP features to the UDP protocol. The application(s) that send and receive data use stream oriented calls to pass data to the ATP application that packetizes the data to be sent and de-packetizes the data that is received so that the packet orientation of UDP is hidden from the applications that provide and use the data. The ATP application uses separate execution threads to send and receive data. Threads provide independent execution capabilities.

There are three important times in the ATP application: the receive time out (acknowledgement time in the application), the send delay time, and the send timeout time. The receive timeout is the time between acknowledgement messages (ack). The sender calculates the acknowledgement time for use by the receiver. The send delay time is the time between each sent packet. The send timeout time is the time when a packet will normally be resent if no acknowledgement is received. All of these times are adapted to the changing conditions that can occur in a wireless connection and this adaptation occurs each time that an acknowledgement message is received.

Packets are paced while sending to avoid backing too much data up before the wireless link There is a target for how many packets should be in transit (that is sent but not yet acknowledged) when an ack is received. If there are too few packets in transit then one cannot adapt as quickly as one would like when network conditions improve and data is being transferred faster than previously. If there are too many packets in transit than it takes too long for a resent packet to reach the destination and throttling occurs in the ATP application and/or the application that uses the data or extra timeouts and resends can occur. Both of these occurrences reduce the effectiveness of the wireless link

The header for every data packet includes a sequence number that indicates the position of the data in the data stream. When each packets is received, it is placed at the tail of the receive queue. If the packets are received in sequence number order, the tail of the queue is where the packet should be so no additional action is needed. If a packet is received out of order, the packet is discarded if it's sequence number is a duplicate of an existing packet or is out of the range covered by the receive queue. Otherwise, the packet data is moved to the correct position in the queue. Data can only be consumed by an application from the head of the queue. If the packet with this sequence number has not arrived, the application cannot proceed even if other nodes in the queue are ready due to the logical stream orientation of the connection.

Application and ATP Send Threads

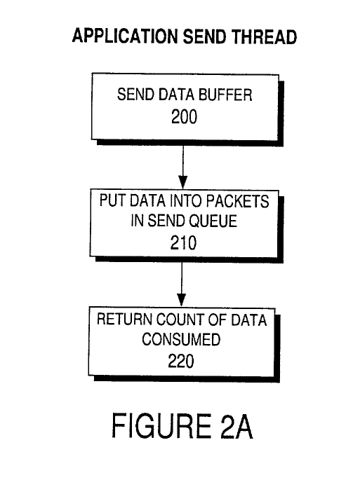

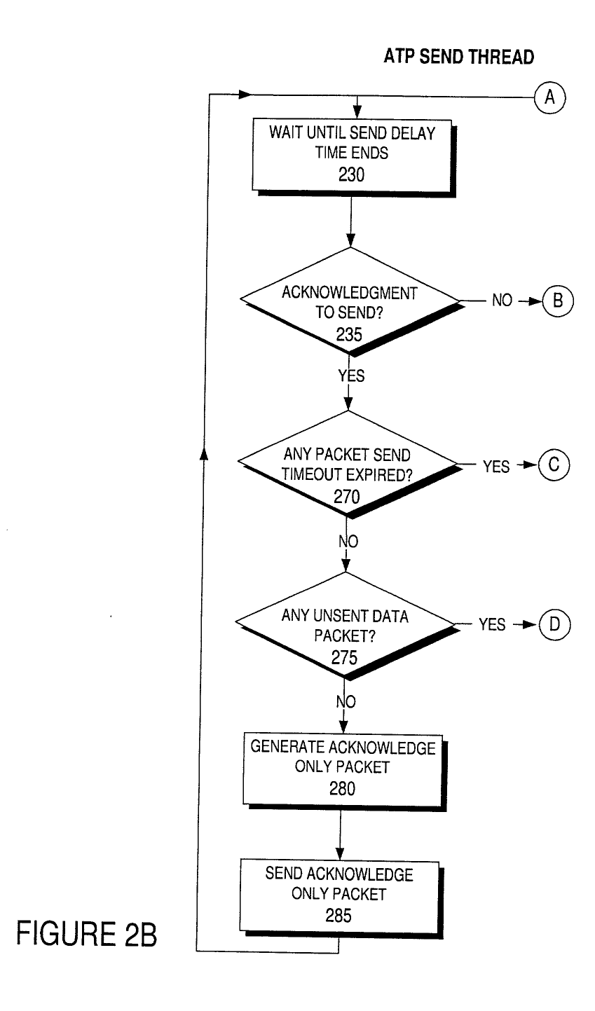

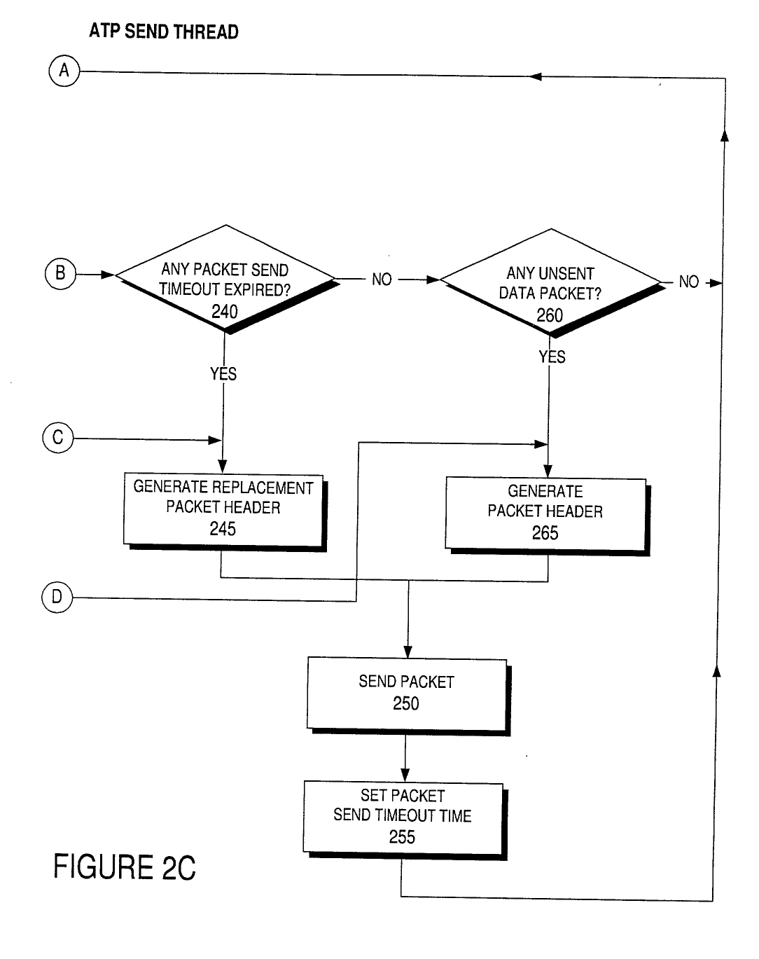

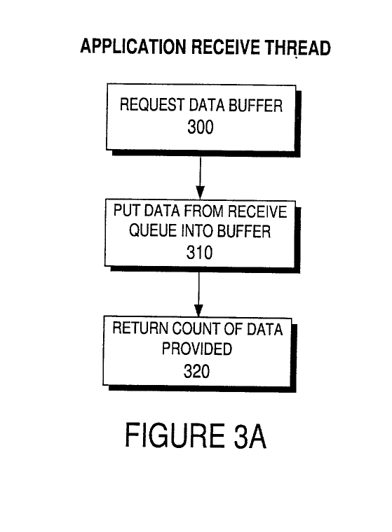

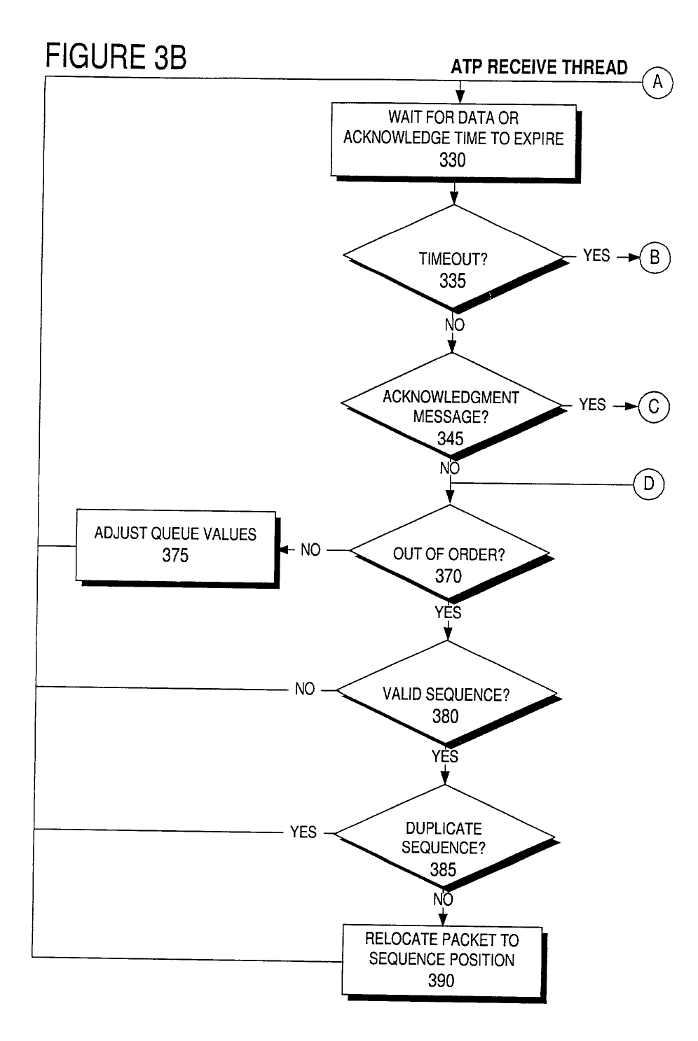

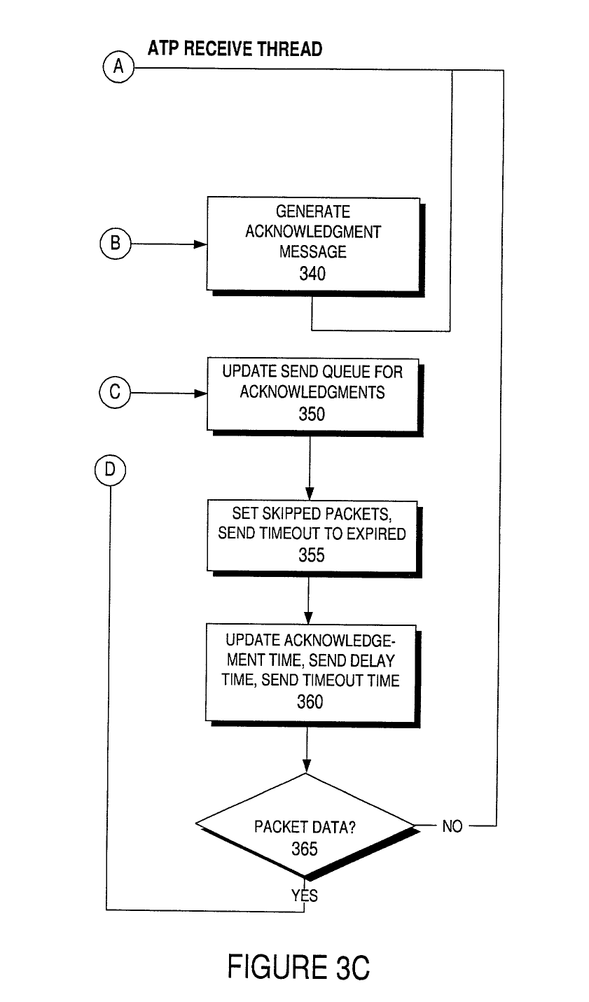

One embodiment of this protocol is shown in FIGS. 2A-2B and 3A-3B. FIGS. 2A and 2B illustrate application and ATP send threads. An application send thread operates as shown in FIG. 2A where it sends a data buffer at step 200, puts data into packets in a send queue at step 210, and returns a count of the data consumed at step 220.

The ATP send thread is shown in FIG. 2B. At step 230, the system waits until the send delay time ends. Then, at step 235, it is determined whether there is an acknowledgment to send, indicating that the packets have been received. If there is not, then it is determined whether there are any packets where the send timeout has expired at step 240, indicating that the packet acknowledgment has not been received from its destination. If so, a replacement packet header is generated (step 245), the packet is sent (step 250), the packets send timeout time is set (step 255), and the process repeats at step 230.

If, however, at step 240 no send timeout has expired for the packet, it is determined at step 260 whether there are any unsent data packets, indicating that a packet has not been received from its destination. If so, a packet header is generated at step 265, the packet is sent (step 250), the packets send timeout time is set (step 255), and the process repeats at step 230. If at step 260 there are not any unsent packets, the process simply repeats at step 230.

At step 235 if there was initially an acknowledgment to send, then it is determined at step 270 whether the send timeout has expired for any packet. If so, the process repeats at step 245. Otherwise, it is determined at step 275 whether there is any unsent data packet. If so, the process repeats at step 265. If not, an acknowledge only packet is generated at step 280, the acknowledge only packet is sent at step 285, and the process repeats at step 230.

Application and ATP Receive Threads

FIGS. 3A and 3B illustrate application and ATP receive threads. An application receive thread operates as shown in FIG. 3A where it requests a data buffer at step 300, puts data from a receive queue into the buffer at step 210, and returns a count of the data provided at step 320.

The ATP receive thread is shown in FIG. 3B. At step 330, the system waits for data or the acknowledge time to expire. Then, at step 335, it is determined whether there is a timeout. If there is, an acknowledgment message is generated at step 340 and the process repeats at step 330. If there is a timeout at step 335, then it is determined whether an acknowledgment message is needed at step 345. If so, the send queue is updated for acknowledgments at step 350, and the skipped packets send timeout is set to expired at step 355, the acknowledgment time, send delaytime, and send timeout time are updated (step 360), since the characteristics of the channel have changed. Then, it is determined whether there is any packet data at step 365. If not, the process repeats at step 330.

If there is packet data at step 365 or if an acknowledge message is not needed at step 345, then at step 370 it is determined if the packets are out of order. If they are not, the queue values are adjusted at step 375 and the process repeats at step 330. If the packets are out of order at step 370, then it is determined at step 380 if this is a valid sequence. If not, the process repeats at step 330. Otherwise, it is determined at step 385 whether this is a duplicate sequence. If so, the process repeats at step 330. Otherwise, the packet is relocated to its proper sequence position at step 390 and the process repeats at step 330.

Initialization

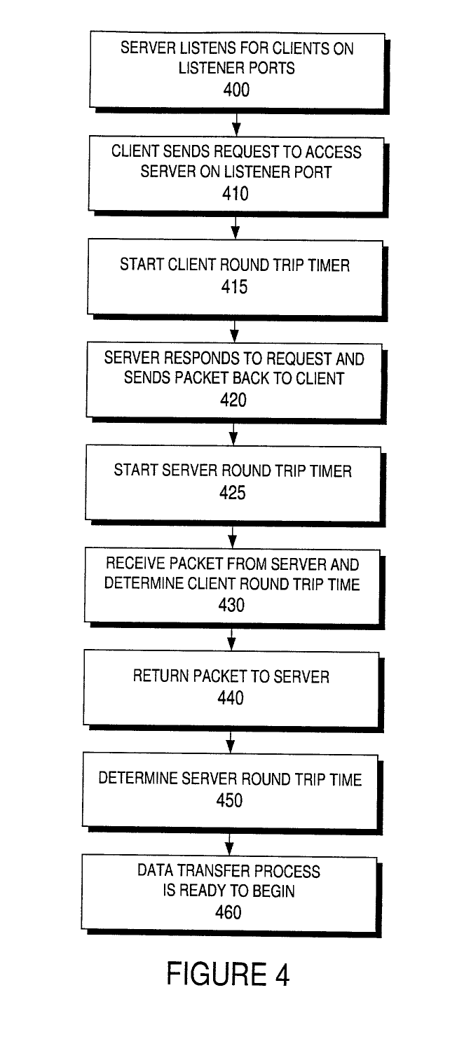

When the connection between the client and server is established, an initial time for expected acknowledgment and send delay are calculated. FIG. 4 shows how the initial expected acknowledgment time is determined. The server is continuallylistening on a series of listener/data ports at step 400. When the connection between the client and server is required, the client sends a request for access to the server on a randomly determined listener/data port at step 410 and starts the client round trip timer at step 415.

At step 420, the server responds to the request and returns the packet to the client and starts the server round trip timer at step 425. Then, at step 430 the client receives the packet from the server and determines the client round trip time as the interval between steps 415 and 430. The client then returns the packet to the server at step 440 using the data port.

The server round trip time is determined at step 450 as the interval between step 425 and step 450. The connection is now complete and the data transfer process may begin at step 460. The round trip time is used to determine the expected acknowledgment time, the send delay time, and the send timeout time. The send delay interval is inserted between each packet that is sent.

Expected Acknowledgment Time Adjustment

A similar round trip time calculation occurs with respect to each set of transmitted packets and the received acknowledgment. The expected acknowledgment time is adjusted with respect to all subsequent packets based on the number of packets acknowledged and the number expected. This number of packets acknowledged may be adjusted if there is no packet to send when the send delay expires. The acknowledgment time is used to determine when the next acknowledgment packet should be sent without resorting to a scheme like TCP/IP where the system waits for missing packets introducing an unacceptably large latency.

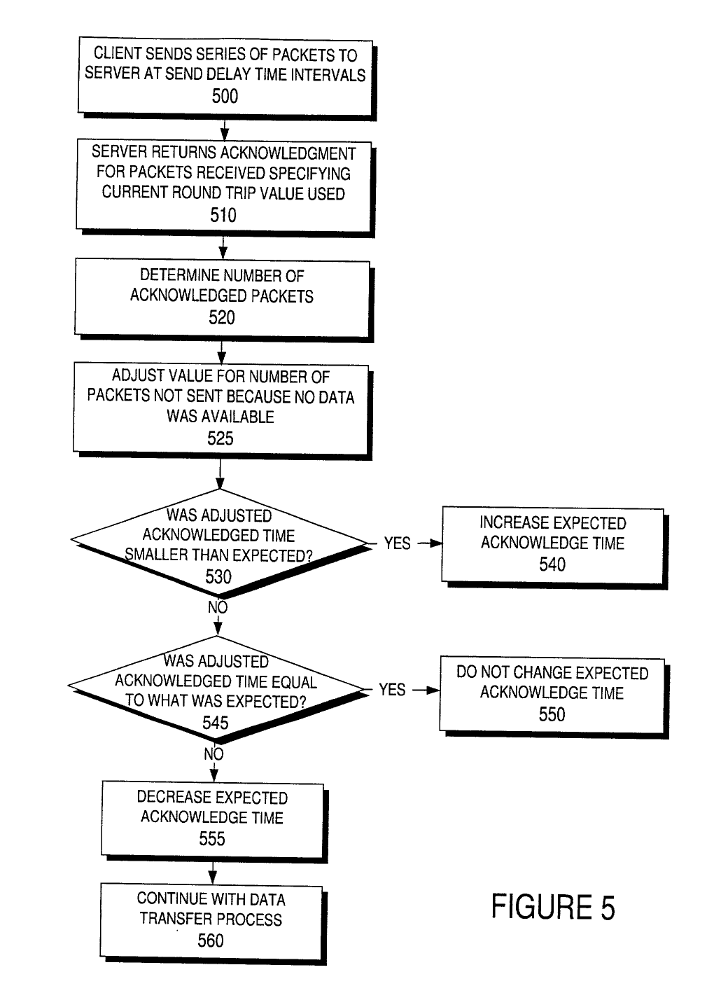

FIG. 5 shows one embodiment of the acknowledgment time calculation with respect to a client as a sender and a server as a receiver. The process, however, is reversible where the client may be the receiver and the server may be the sender. At step 500 the client sends a series of packets to the server at send delay time intervals. At step 510, the server returns an acknowledgement to the client for the packets received specifying the current round trip value used. Some packets may still be in transit Next, at step 520, the number of acknowledged packets is determined. At step 525 this value is adjusted for packets not sent because no data was available to send. Then, at step 530, it is determined whether the adjusted number acknowledged was smaller than expected. If it is, then at step 540, the expected acknowledgment time is increased. Otherwise, at step 545, it is determined whether the adjusted number acknowledged was equal to the number expected. If so, the expected acknowledge time is left unchanged at step 550. Otherwise, the expected acknowledgment time is decreased at step 555 and the data transfer process continues at step 560.

Send Delay Time Adjustment

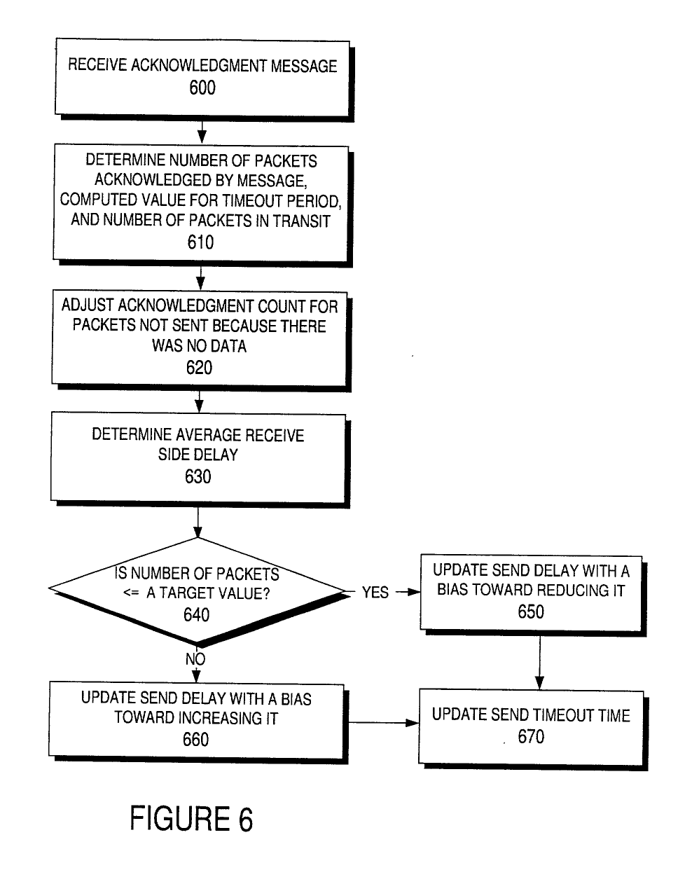

FIG. 6 shows one embodiment of the send delay time calculation. At step 600, an acknowledgement message is received indicating the packets acknowledged and the acknowledgement timeout used by the sender to schedule the message. At step 610, the receiver of the acknowledgement message determines the number of packets acknowledged by this message; the receiver's computed value for the acknowledgement period; and the number of packets that are in transit. At step 620, the acknowledgement count is also adjusted to take account of send delay time intervals when no packet was sent because no data packets were in the queue to be sent. At step 630, the average receive side delay between packets is determined from the acknowledgement senders acknowledgement time value and the adjusted acknowledgement count value.

At step 640, the number of packets in transit is compared to a target value. If the number is less than or equal to the target at step 640, then the send delay time is updated by a method, step 650, that has a bias towards decreasing the send delay time. If the number is greater than the target value at step 640 then the send delay time is updated by a method, step 660, that has a bias towards increasing the send delay time. After the send delay time has been adjusted at step 650 or step 660, the send timeout time is adjusted at step 670 based on the acknowledgement time measured and computed.

The system of the present invention for dynamically adjusting the acknowledge time, the send delay time, and the send timeout time provides a solution to the problems created by a wireless network link. The present invention can quickly adapt itself to optimize the communication performance over a continually and quickly changing wireless link. The present invention also utilizes a re-send policy that conforms to the characteristics of a wireless connection instead of the optimization for a wired connection that exists in TCP/IP.

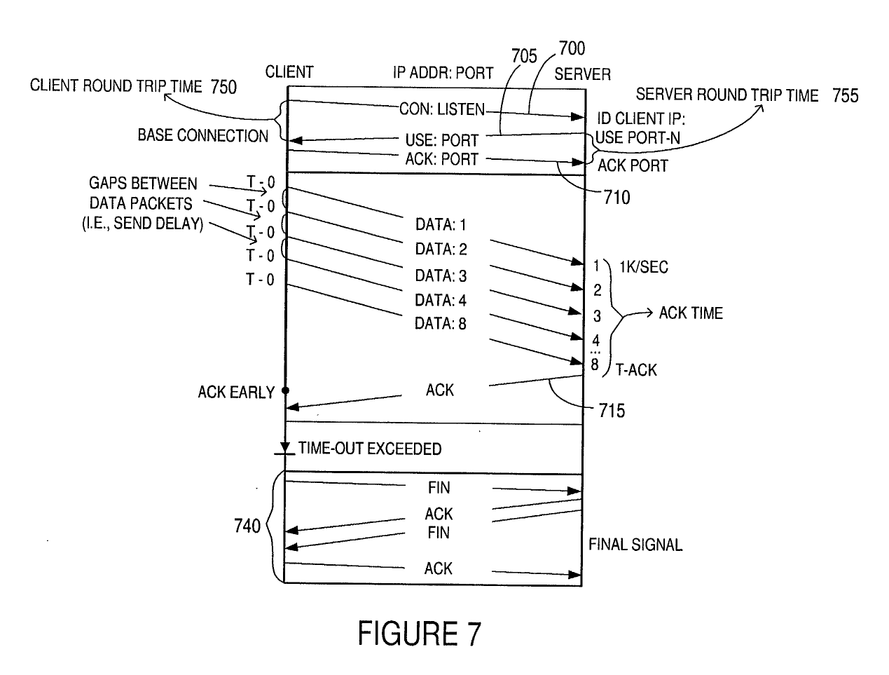

A diagram showing one embodiment of the complete process of initialization and data transfer is shown in FIG. 7. There the basic connection is made bythe client sending a request to the server for a connection along line 700 and the server responding by echoing the packet at line 705. This is termed the client round trip time 750. The client then re-echoes the packet at line 710 and the data transfer process maybegin. The period between lines 705 and 710 is termed the server round trip time 755.

The data transfer process in this example consists of an eight packet transmission. For simplicity only five of the eight packets are labeled as data 1, data 2, data 3, data 4, and data 8. the times (to) represent the send delay times between the packets. When the acknowledgment time is complete, the server sends an acknowledgment of the packets received along line 715. Then the system determines whether the number of acknowledgments was greater than, less than, or equal to the expected values. The expected acknowledgment time for future packets is adjusted based on the number of packets acknowledged. If a packet is not acknowledged by the send timeout time for that packet or the acknowledgment for that packet is skipped, then the system knows the packet probably will never arrive and re-sends it. Finally, a finalization stage 740 is reached and the process ends.

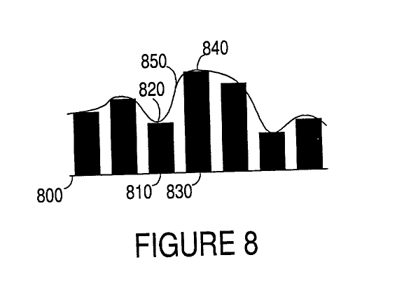

FIG. 8 shows an example of how the gap in transmission is constantly readjusted by various embodiments of the present invention. This constant readjustment as line traffic fluctuates maximizes line usage, which is a primary concern for wireless networks where time on the network is a critical factor with respect to cost. Graph 800 shows different transmission gaps that may change depending on the characteristics of the line, for instance if other users begin to share the same bandwidth. In particular, line usage is maximized, if at time 810 when the expected arrival time 820 is low and at time 830 when expected arrival time 840 is high, there is a gradual adjustment 850 of the expected arrival time.

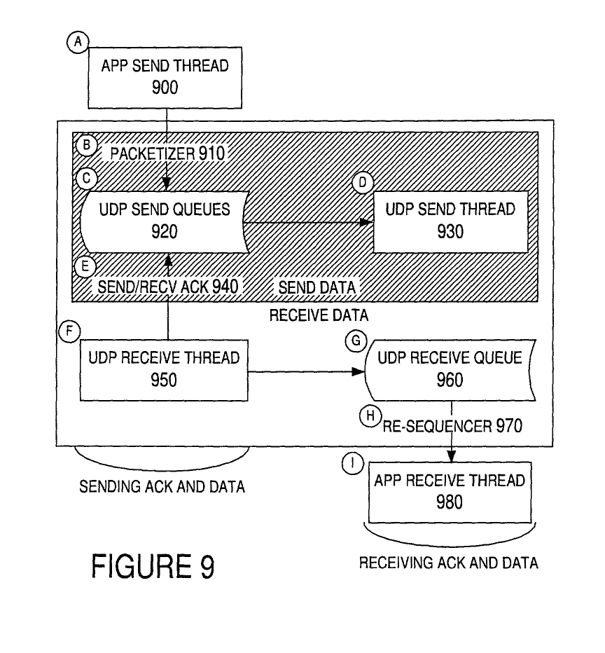

The data transfer process of one embodiment of the adaptive transport protocol is shown in FIG. 9. At block 900 a separate application thread supplies data to be sent using a stream oriented call. Then at block 910 a packetizer is used to break the stream data into packets based on an optimal packet size that are placed in the send queue 920 The send queue 920 holds the packets for eventual transmission. A send thread 930 is used to send packets from the queue at send delay intervals using the standard socket operating system service for the UDP protocol. If an acknowledgment is not received for a packet before a send timeout time for the packet, the send thread 930 will re-send the packet. The send thread 930 is also responsible for sending acknowledgment information when that is available either as separate packets or piggybacked with a data packet, so that round trip times can be used to adjust the rate at which packets are sent, for instance if the characteristics of the channel have changed.

A receive thread 950 is responsible for accepting UDP datagram payloads when they are received. The receive data is added to the receive queue 960 in the queue location specified by the packet sequence number. When the acknowledgment time interval has passed, an acknowledgment message is generated. This message is sent bythe send thread 930 at the first opportuity as previously indicated. A separate application acquires the data in a stream oriented call from a resequencer or a de-packetizer 970.

Connection Termination Process

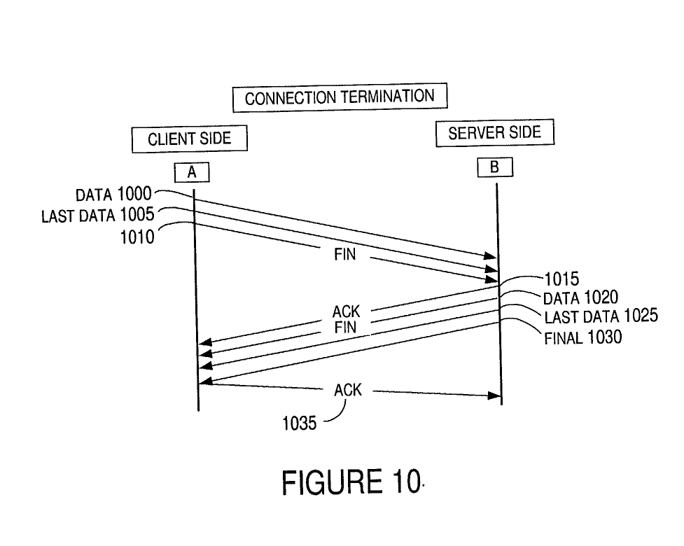

When the client has finished sending all data packets, it sends a final (fin) packet to advise the server that the data transfer is finished. When the server receives the fin packet it acknowledges its receipt by sending an acknowledgment packet back to the client in addition to its own fin packet. The client then acknowledges the server's fin packet and sends back an acknowledgment packet to close the connection. This process is illustrated in FIG. 10.

At line 1000, data is sent. At line 1005, a last data packet is sent. When the client has finished sending all of its data it sends a fin packet along line 1010. When the server receives the fin packet, it returns an acknowledgment packet back to the client at line 1015 followed by its data 1020 and its last data 1025. then it sends its own fin packet 1030 when all outstanding requests have been completed, signaling ready to terminate. Finally, the client receives the fin packet and sends to the server an acknowledgement to disconnect at step 1035.

IDP Packet Format

IDP is a simple, datagram-oriented, transport layer protocol. Each output operation by a process produces exactly one UDP datagram, which causes one IP datagram to be sent. This is different from a stream oriented protocol like TCP where the amount of data written by an application may have little relationship to what actually gets sent in a single IP datagram. UDP sends datagrams written bythe application to the IP layer, but there is no reliability or guarantee that the data was received at its destination point. This functionality is supplied by the ATP application combined with the ATP protocol that is included in the UDP payload.

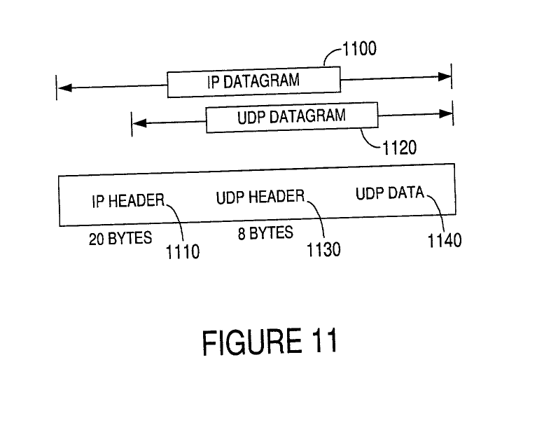

FIG. 11 shows how a UDP datagram is encapsulated as an IP datagram. IP datagram 1100 comprises an IP header 1110 and a UDP datagram 1120. UDP datagram 1120 comprises a UDP header 1130, which maybe eight bytes and UDP data 1140. In practical terms, the maximum size of an IP datagram is 65535 bytes, imposed bythe 16-bit total length field in the IP header. With an IP header of 20 bytes and a UDP header of 8 bytes, this leaves a maximum of 65507 bytes of user data in a UDP datagram. Most implementations provide less than the maximum, for instance where an application program interface uses send and receive buffers of smaller size or where a kernel implementation of TCP/IP limits the size to less than the maximum.

A UDP length field includes the UDP header and the UDP payload and is measured in bytes with a mnimum value of eight bytes. Sending a UDP payload with a length 0 bytes is permitted as well. The length of the UDP datagram is the total IP datagram length minus the length of the IP header, which is specified by the header length field. The ATP protocol resides in a header at the front of the UDP payload. In one embodiment, byte 0 of the ATP header contains the message sequence numbers in bits 0-5. Bit 6 is the time-out flag and bit 7 is the acknowledgment flag. In one embodiment, byte 1 is the RTO byte. In another embodiment, byte 2 is acknowledgement bitmap byte 0, byte 3 is bitmap byte 1, byte 4 is bitmap byte 2, and byte 5 is bitmap byte 3. Acknowledgement bitmap bytes may be included in some embodiments only when needed.

Data Piggybacking

One embodiment of the present invention uses data piggybacking. Data piggybacking refers to a method for placing data and acknowledgments within the same packet to conserve bandwidth. In particular, wireless environments are subject to asynunetrical channels. This means that the transmission in one direction might have different characteristics than the transmission in the other direction. One channel, for instance, might transmit with more noise and be more error prone. In addition, there may be multiple channels in one direction with only a single channel in the other direction depending on the geographic location where the channel is being used.

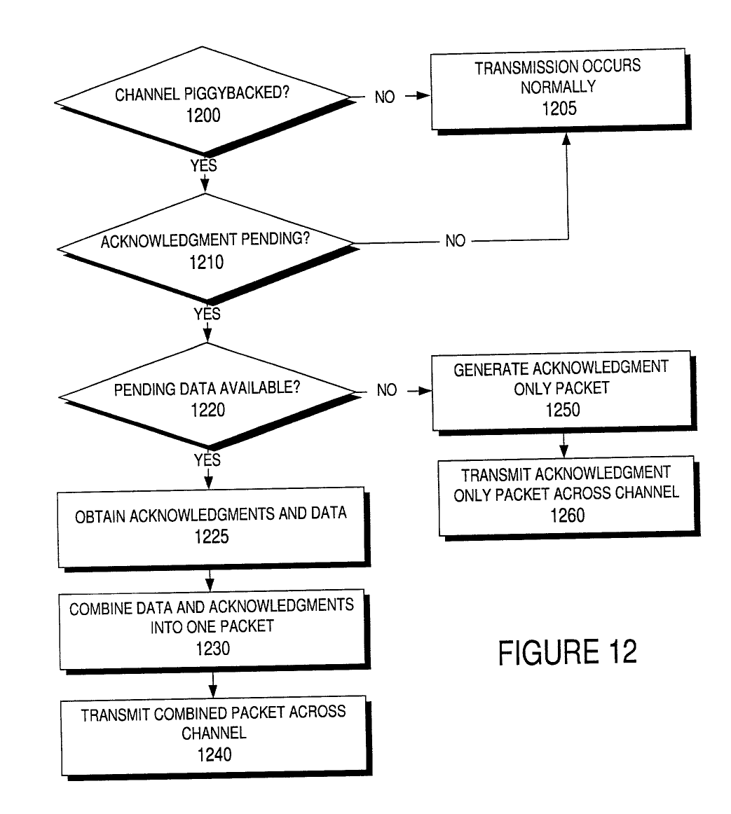

In circumstances like this, or in other circumstances where it is generally useful to improve efficiency, it is particularly beneficial to minimize transmissions across problematic channels. One way to achieve this goal is to piggyback acknowledgments and data into the same packet. This embodiment of the present invention is shown in FIG. 12. At step 1200 it is determined whether the channel is piggybacked. If it is not, then transmissions occur normally at step 1205. If it is piggybacked, then at step 1210 it is determined if an acknowledgment is pending. If not the transmission occurs normally at step 1205. At step 1220, it is determined if there is pending data available. If there is, then acknowledgment and data are obtained at step 1225 and at step 1230 they are combined into a single packet. Then, at step 1240, the combined packet is transmitted across the channel. If no data is pending at step 1220, then an acknowledgment only packet is generated at step 1250 and this packet is transmitted across the channel at step 1260.

Channel Volatility

In one embodiment, the volatility of the channel is calculated in real-time. As a large series of packets is transmitted, the variation in the expected acknowledge times is determined. If the variance is relatively large, then it may be determined that the channel is very volatile and the timeout for the expected acknowledgment time should be extended further. If the variance is relatively small, then the timeout periods maybe reduced (i.e.,.if the packets do not arrive it is very likely that they were lost and not delayed in transit to arrive at a later time).

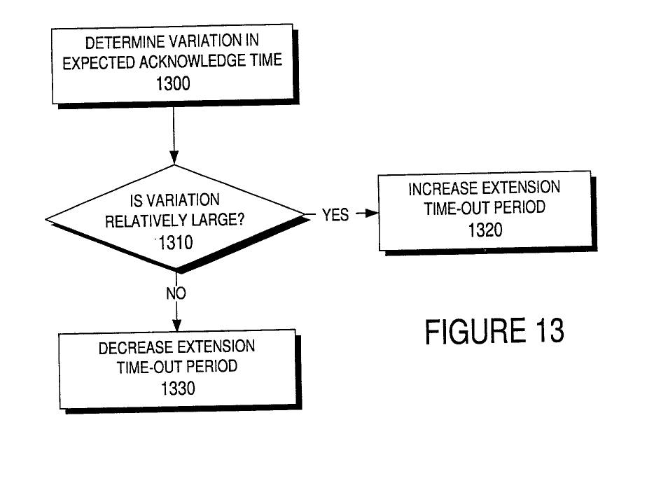

An embodiment of the present invention that accounts for channel volatility is shown in FIG. 13. As packets are transmitted, a variation in the expected acknowledge time is computed at step 1300. Then it is determined whether the variation is relatively large at step 1310. The determination of what is relatively large may be based on the variation exceeding a standard deviation for the expected acknowledgment times. If the variation is relatively large, then the extension of the time out period should be increased at step 1320. Otherwise, it is known that the channel is secure so the time out periods may be tightened at step 1330. This means that since the channel is secure, then if the packet does not arrive in time it is safer to assume that it was lost in transit and will never arrive and in that case it should be re-transmitted.

Dynamic Packet Sizing

In one embodiment of the present invention the packets transmitted from the client to the server are variable in size depending on the characteristics of the channel or the maximum size packet that will be accepted at the packet's destination. In particular, UDP sends datagrams only and does not check to see if the data is received at its destination point. Since the application must assess the size of the resulting IP datagram, if it exceeds the network's maximum transfer unit the IP datagram becomes fragmented, thus further slowing data communication.

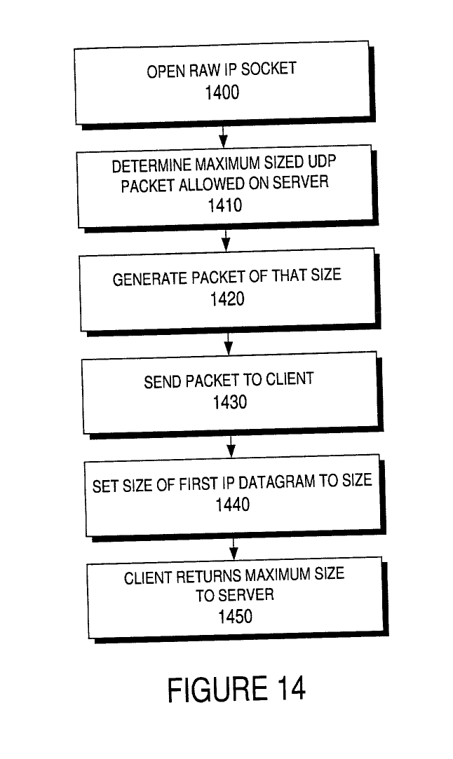

To dynamically re-size packets based on these considerations, one embodiment of the present invention functions as shown in FIG. 14. First, the system opens a raw IP socket on the client at step 1400. The server determines the maximum sized UDP packet allowed on the server at step 1410 and generates a packet of that size at step 1420. That packet is sent to the client at step 1430. That packet may be broken up into multiple smaller packets for any node that cannot handle the initial packet size. The size of the first IP datagram received from the server on the raw IP socket is then set to the maximum packet size that may be handled by the connection at step 1440. The client then returns this optimum size to the server at step 1450. The client and server may use this packet as the optimal size for their packets. The role of the server and client in determining the optimal packet size may be reversed without affecting the process.

Firewall

Firewalls often treat UDP packets in unexpected ways. Using TCP/IP this is not a problem because it is a connection oriented protocol and the firewall is aware of what socket the conversation was initiated on. In UDP, however, this information is not known. To pass through firewalls with the present invention, a technique is implemented to manage the dynamic assignment of UDP ports to a pre-defined range and firewall operators are allowed to open the firewall to those ranges.

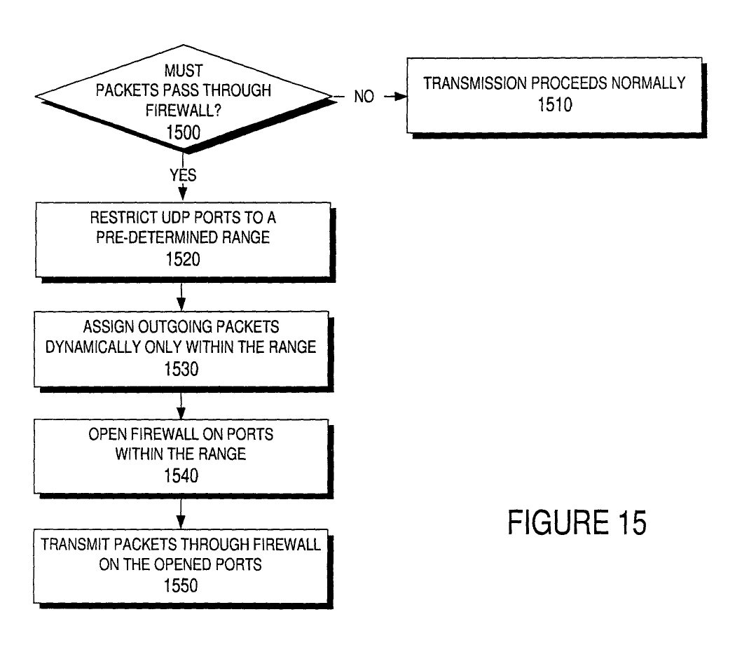

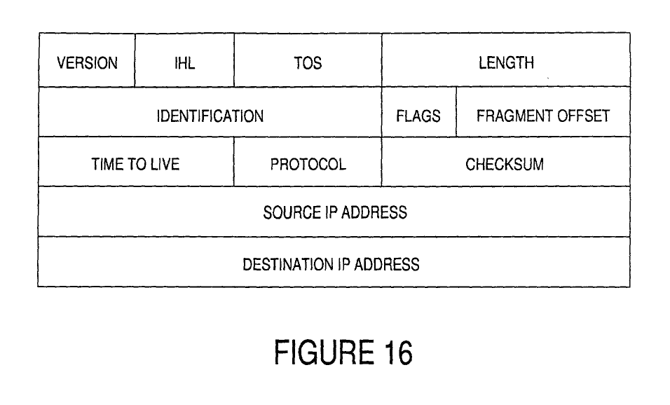

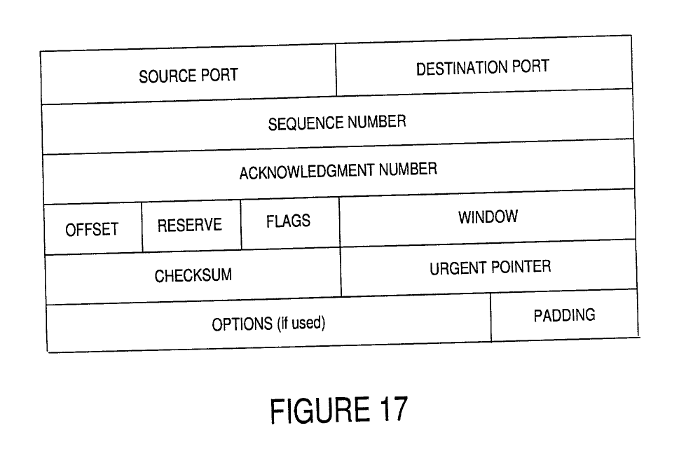

FIG. 15 shows how firewalls are managed in one embodiment of the present invention. At step 1500 it is determined if the packets must pass through a firewall. If they do not, transmissions proceed normally at step 1510. Otherwise, the available UDP ports are restricted to a predetermined range at step 1520. Then, as client select ports they are dynamically assigned only within the range at step 1530. On the other end of the firewall, an operator opens the firewall on ports within the range at step 1540 and packets are transmitted through the firewall on those ports at step 1550.

Thus, an adaptive transport protocol is described in conjunction with one or more specific embodiments. The invention is defined by the claims and their full scope of equivalents.

1. A method for transmitting data across a medium comprising:
determining an expected acknowledgment time, a send delay interval time, and a send timeout time;
sending a series of ordered packets from a source to a destination;
receiving said ordered packets at said destination;
sending an acknowledgment indicating a receipt of said ordered packets to said source;
adjusting said expected acknowledgment time, said send delay interval time, and said send timeout value, if necessary; and
re-sending one or more of said ordered packets using said send timeout time.

2. The method of claim 1 wherein said source is a client or a server.

3. The method of claim 1 wherein said destination is a client or a server.

4. The method of claim 1 wherein said step of adjusting comprises:
increasing said send delay interval time if a number of packets in transit increases or a receive delay time increases.

5. The method of claim 1 wherein said step of adjusting comprises:
decreasing said send delay interval time if a number of packets in transit decreases beyond a target or a receive delay time decreases.

6. The method of claim 1 wherein said step of adjusting comprises:
sending said packet send timeout time to an expired time, if one of said packets is not acknowledged in order.

7. The method of claim 1 wherein said step of adjusting comprises:
increasing said packet send timeout time for one or more subsequent packets, if all of said packets are acknowledged in order

8. The method of claim 1 further comprising:
determining an optimal size for said packets.

9. The method of claim 1 wherein said step of adjusting further comprises:
smoothing a variance in said expected acknowledgment time, said send delay interval time, and/or said send timeout value by dampening said variance towards a prior value.

10. The method of claim 1 wherein said step of sending further comprises:
determining if a firewall resides between said source and said destination;
restricting said packets to a range of ports;
opening said range of ports on said firewall; and
sending said packets through said range of ports.

11. A computer program product comprising:
a computer usable medium having computer readable program code embodied therein configured to transmit data across a medium, said computer program product comprising:
computer readable code configured to cause a computer to determine an expected acknowledgment time, a send delay interval time, and a send timeout time;
computer readable code configured to cause a computer to send a series of ordered packets from a source to a destination;
computer readable code configured to cause a computer to receive said ordered packets at said destination;
computer readable code configured to cause a computer to send an acknowledgment indicating a receipt of said ordered packets to said source;
computer readable code configured to cause a computer to adjust said expected acknowledgment time, said send delay interval time, and said send timeout value, if necessary and computer readable code configured to cause a computer to re-send one or more of said ordered packets using said send timeout time.

12. The computer program product of claim 11 wherein said source is a client or a server.

13. The computer program product of claim 1 wherein said destination is a client or a server.

14. The computer program product of claim 11 wherein said computer readable code configured to cause a computer to adjust comprises:
computer readable code configured to cause a computer to increase said send delay interval time if a number of packets in transit increases or a receive delay time increases.

15. The computer program product of claim 11 wherein said computer readable code configured to cause a computer to adjust comprises:
computer readable code configured to cause a computer to decrease said send delay interval time if a number of packets in transit decreases beyond a target or a receive delay time decreases.

16. The computer program product of claim 11 wherein said computer readable code configured to cause a computer to adjust comprises:
computer readable code configured to cause a computer to send said packet send timeout time to an expired time, if one of said packets is not acknowledged in order.

17. The computer program product of claim 11 wherein said computer readable code configured to cause a computer to adjust comprises:
computer readable code configured to cause a computer to increase said packet send timeout time for one or more subsequent packets, if a send timeout for one packet occurs and all of said packets are acknowledged in order.

18. The computer program product of claim 11 further comprising:
computer readable code configured to cause a computer to determine an optimal size for said packets.

19. The computer program product of claim 11 wherein said computer readable code configured to cause a computer to adjust further comprises:
computer readable code configured to cause a computer to smooth a variance in said expected acknowledgment time, said send delay interval time, and/or said send timeout value by dampening said variance towards a prior value.

20. The computer program product of claim 11 wherein said computer readable code configured to cause a computer to send further comprises:
computer readable code configured to cause a computer to determine if a firewall resides between said source and said destination;
computer readable code configured to cause a computer to restrict said packets to a range of ports;
computer readable code configured to cause a computer to open said range of ports on said firewall; and
computer readable code configured to cause a computer to send said packets through said range of ports.

21. An adaptive protocol comprising:
an expected acknowledgment time, a send delay interval time, and a send timeout time, configured to be determined;
a series of ordered packets configured to be sent from a source and received at a destination;
an acknowledgment configured to be sent indicating a receipt of said ordered packets to said source;
an adjuster configured to adjust said expected acknowledgment time, said send delay interval time, and said send timeout value, if necessary, and
a re-sender configured to re-send one or more of said ordered packets using said send timeout time.

22. The adaptive protocol of claim 21 wherein said source is a client or a server.

23. The adaptive protocol of claim 21 wherein said destination is a client or a server.

24. The adaptive protocol of claim 21 wherein said adjuster increases said send delay interval time if a number of packets in transit increases or a receive delay time increases.

25. The adaptive protocol of claim 21 wherein said adjuster decreases said send delay interval time if a number of packets in transit decreases beyond a target or a receive delay time decreases.

26. The adaptive protocol of claim 21 wherein said adjuster sends said packet send timeout time to an expired time, if one of said packets is not acknowledged in order.

27. The adaptive protocol of claim 21 wherein said adjuster increases said packet send timeout time for one or more subsequent packets, if all of said packets are acknowledged in order

28. The adaptive protocol of claim 21 further comprising:
a determiner for determining an optimal size for said packets.

29. The adaptive protocol of claim 21 wherein said adjuster smoothes a variance in said expected acknowledgment time, said send delay interval time, and/or said send timeout value by dampening said variance towards a prior value.

30. The adaptive protocol of claim 21 further comprising:
a firewall manager configured to determine if a firewall resides between said source and said destination;
restricting said packets to a range of ports;
opening said range of ports on said firewall; and
sending said packets through said range of ports.
